(19) United States
(12) Patent Application Publication
(10) Pub. No.: US 2006/0252438 A1
(43) Pub. Date: Nov. 9, 2006

(54) Determining user equipment time zones for time-based service fulfillment

(76) Inventors: Jarkko Henrikki Ansamaa, Helsinki (FI); Martti T. Ylikoski, Helsinki (FI)

Correspondence Address: Hollingsworth & Funk, 8009 34th Avenue South, Suite 125, Minneapolis, MN, 55425, US

(21) Appl. No.: 11/121,764

(22) Filed: May 4, 2005

(51) Int. Cl. H04B 7/005

(52) U.S. Cl. 455/503; 455/456.1

(57) ABSTRACT

Providing time-based network services to a mobile device involves determining a location of a network access point accessible by the mobile device. A service provider targets a service event for the mobile device. A time zone of the mobile device is determined based on the location of the network access point. An indicator of the time zone of the mobile device is communicated to the service provider arrangement. An event time for a service event based on the time zone is updated by the service provider based on the time zone indicator. Thereafter, the time zone of the mobile device may be tracked by monitoring the locations of network access points being used by the mobile device, and determining an updated time zone based on these locations. The updated time zone information can be used to update the service event.

### FIELD OF THE INVENTION

This invention relates in general to communications networks, and more particularly to providing network services via mobile communications networks.

### BACKGROUND OF THE INVENTION

Mobile communications devices such as cell phones are gaining wide acceptance. The popularity of these devices is due their portability as well as the advanced features being added to such devices. Modern cell phones and related devices offer an ever-growing list of digital capabilities. For example, many phones may be equipped with software that allows the devices to receive customized network services for the benefit of users.

One type of network services usable by a mobile device includes a data subscription service. Data subscription may involve any type of service where a network entity (e.g., a server) provides requested data either once or on a recurring basis. For example, a newsfeed service that provides sports scores may be considered a subscription service.

Some subscription services may be event based, such that the service is activated in response to a triggering event. One common triggering event is the passage of time. For example, a user may want to schedule a certain data service (e.g., send a message, receive a download, synchronize data) to occur at a particular time of day. The user will usually be interested in the event occurring at a particular local time, i.e., the time associated with the user's current location.

Where computing devices are stationary, the local time zone may be set during the device's initial setup. Mobile devices, however, are designed to move with the user. With the advent of interoperable global telecommunications networks, mobile devices can appear anywhere in the world at any given time zone.

A network service entity that desires to send to the mobile device a service that is triggered on the user's local time will have no way of determining the current time zone of the user. Therefore, improvements are needed that will allow mobile devices to take advantage of time-based subscription services no matter where in the world the devices are located.

### SUMMARY OF THE INVENTION

The present disclosure relates to providing time-based network services via mobile communications networks. In accordance with one embodiment of the invention, a method of providing time-based network services to a mobile device involves determining a location of a network access point accessible by the mobile device. A time zone of the mobile device is determined based on the location of the network access point. An indicator of the time zone of the mobile device is communicated to a service provider arrangement, and an event time for a service event based on the time zone is determined. The service provider targets the service event for the mobile device.

In more particular embodiments of the invention, an updated time zone of the mobile device is determined based on repeated monitoring of network access points being accessed by the mobile device, and an indicator of the updated time zone is communicated to the service provider arrangement. The event time for the service event is updated based on the updated time zone. The repeated monitoring of network access points being accessed by the mobile device may involve tracking handovers between a first access network that the mobile device is exiting and a second access network the mobile device is entering.

In other, more particular embodiments of the invention, determining the location of the network access point involves determining the location of the network access point when the mobile device initiates a connection at the network access point. Initiating the connection at the network access point may involve initiating a packet switch data connection, such as a Packet Data Protocol (PDP) context setup. In other arrangements, determining the time zone of the mobile device based on the location of the network access points involves determining a current time zone of the mobile device when the mobile device is currently disconnected from the network based on the location of a last network access point accessed by the mobile device.

In other, more particular embodiments of the invention, the method may further involve subscribing to the time-based service via the mobile terminal and/or via a third-party device that is separate from the mobile terminal. The method may further involve storing the indicator of the time zone at a location registry arrangement.

In another, more particular embodiment of the invention, communicating the indicator of the time zone of the mobile device to the service provider arrangement may involve retrieving the indicator of the time zone from the location registry arrangement. In such a case, the method may further involve determining an updated time zone of the mobile device based on repeated monitoring of location of network access points being accessed by the mobile device, and storing an indicator of the updated time zone at the location registry arrangement. Communicating the indicator of the time zone of the mobile device to the service provider arrangement may involve retrieving the indicator of the time zone from the location registry arrangement when the service event is requested at the service provider. Communicating the indicator of the time zone of the mobile device to the service provider arrangement may also involve retrieving the indicator of the time zone from the location registry arrangement when the mobile device initiates a connection at the network access point.

In another, more particular embodiment of the invention, determining the time zone of the mobile device based on the location of the network access point involves sending a location-signaling message to the network access point. Sending the signaling message may involve sending at least one of a Location Immediate Request (LIR) message and a Location Deferred Request (LDR) message.

In another embodiment of the invention, a method of providing time-based network services to a mobile device involves determining locations of the mobile device based on repeated monitoring of network access points accessed by the mobile device. Updated time zones of the mobile device are determined based on the locations of the network access points. Indicators of the updated time zones of the mobile device are communicated to a service provider arrangement, and an event time for a service event is determined based on the updated time zones. The service provider targets the service event for the mobile device.

In another embodiment of the invention, a data-processing arrangement includes a network interface capable of receiving data via a network. A processor is coupled to the network interface and memory is coupled to the processor. The memory has a service ordering and delivery module that causes the processor to receive via the network interface a service request for a time-based service event targeted for a mobile device. The processor determines a time zone of the mobile device based on a location of a network access point accessible by the mobile device, and fulfills the service request using the time zone to determine an event time of the time-based service event.

In a more particular embodiment of the invention, the data-processing arrangement includes a location module that causes the processor to determine the location of the network access point via a location registry arrangement. The location registry arrangement may include any combination of a Home Location Register (HLR) and a Home Subscriber Service (HSS).

In another embodiment of the invention, a data-processing arrangement includes a core network interface capable of receiving data via a core network and an access network interface capable of communicating with devices coupled to a mobile access network. A processor is coupled to the network interface; and memory is coupled to the processor. The memory has an access gateway module that causes the processor to receive a request for a time zone of a mobile device that is capable of accessing the access network interface. The processor determines the time zone of the mobile device based on a location of a network access point of the access network used by the mobile device and responds to the request with a reply that includes the time zone of the mobile device.

In another embodiment of the invention, a data-processing arrangement includes a network interface capable of receiving data via a network. A processor is coupled to the network interface and a memory is coupled to the processor. The memory has a location register module that causes the processor to determine a time zone of a mobile device based on a location of a network access point accessible by the mobile device. The processor stores the time zone of the mobile device with location data associated with the mobile device, and fulfills requests for the time zone of the mobile device. The data-processing arrangement may containing a location signaling module that causes the processor to determine the time zone of the mobile device by sending a location signaling message to an access network that includes the network access point accessible by the mobile device.

In another embodiment of the invention, a system for providing time-based network services to a mobile device includes means for determining a location of a network access point accessible by the mobile device; means for determining a time zone of the mobile device based on the location of the network access point; means for communicating an indicator of the time zone of the mobile device to a service provider arrangement; means for determining an event time for a service event based on the time zone; and; means for targeting the service event for the mobile device.

These and various other advantages and features of novelty which characterize the invention are pointed out with particularity in the claims annexed hereto and form a part hereof. However, for a better understanding of the invention, its advantages, and the objects obtained by its use, reference should be made to the drawings which form a further part hereof, and to accompanying descriptive matter, in which there are illustrated and described specific examples of a system, apparatus, and method in accordance with the invention.

### BRIEF DESCRIPTION OF THE DRAWINGS

The invention is described in connection with the embodiments illustrated in the following diagrams.

FIG. 1 is a block diagram illustrating a system environment in which various embodiments of the invention may be practiced;

FIGS. 2A-C are block diagrams illustrating home network and roaming scenarios in accordance with embodiments of the present invention;

FIG. 3 is a sequence diagram illustrating time zone location resolution upon connection setup according to embodiments of the present invention;

FIG. 4 is a sequence diagram illustrating tracking time zone changes within a single access network according to embodiments of the present invention;

FIG. 5 is a sequence diagram illustrating tracking time zone changes when transitioning between access networks according to embodiments of the present invention;

FIG. 6 is a sequence diagram illustrating storing time zone locations in a location register according to embodiments of the present invention;

FIG. 7 is a block diagram illustrating implementations of time zone tracking in a GSM/GPRS network according to embodiments of the present invention;

FIG. 8 is a block diagram illustrating computing arrangements used to implement time zone tracking according to embodiments of the present invention; and

FIGS. 9A-B are flowcharts illustrating procedures for time zone determination and updating according to embodiments of the present invention.

### DETAILED DESCRIPTION OF THE INVENTION

In the following description of various exemplary embodiments, reference is made to the accompanying drawings which form a part hereof, and in which is shown by way of illustration various embodiments in which the invention may be practiced. It is to be understood that other embodiments may be utilized, as structural and operational changes may be made without departing from the scope of the present invention.

Generally, the present disclosure is directed to providing time zone indications to network service elements on behalf of mobile devices that may be located in arbitrary time zones. These time zone indications may be used to accurately determine the local time at the device's present location. This determination of local time can be used to deliver a time-based service that is dependent on the device's local time.

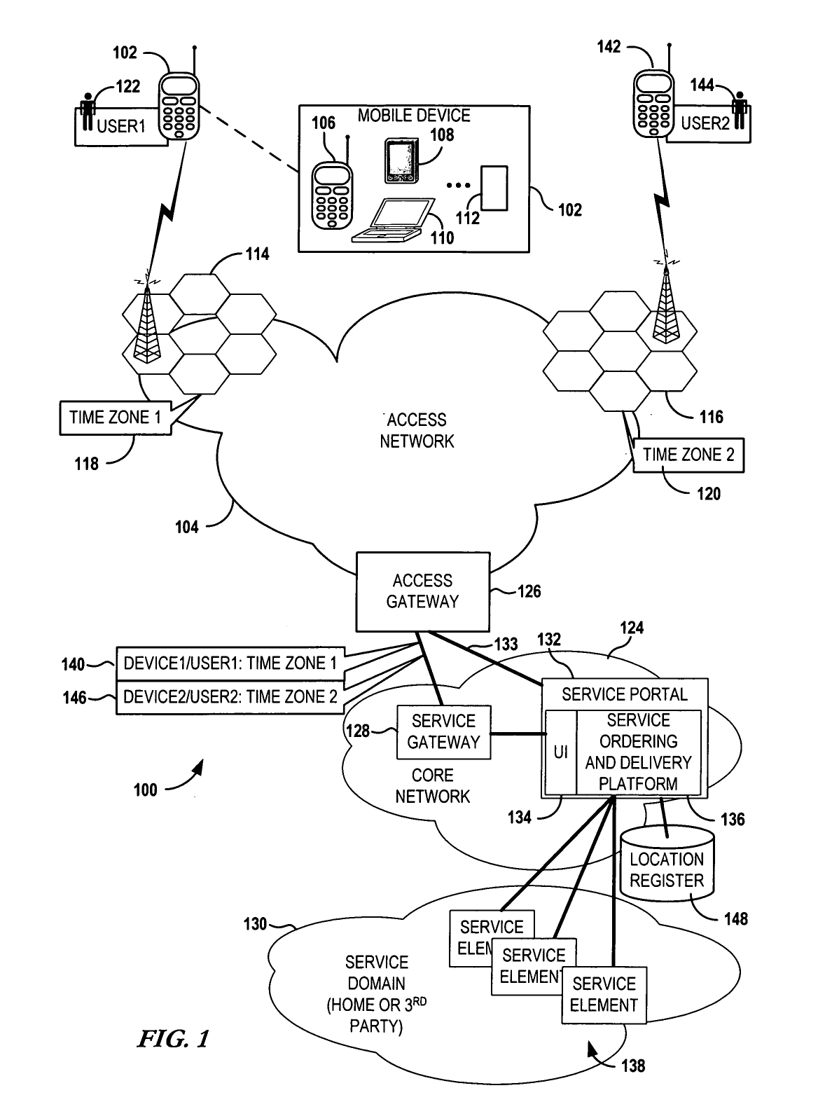

Referring now to FIG. 1, a network environment 100 is illustrated in which various embodiments of the invention may be practiced. Generally, the invention involves at least one mobile device 102 that may be coupled to an access network 104. The mobile device 102 may include any portable data communications apparatus known in the art, including a cellular phone 106, Personal Digital Assistant (PDA) 108, laptop/notebook computer 110, or other device as represented by generic device 112. The mobile device 102 may be coupled to the access network 104 through any combination of wired and wireless communication mediums. The access network 104 generally provides the first connection leg for the mobile device 102. As such, the access network 104 mainly deals with providing and maintaining connectivity with the device 102.

The access network 104 may be small enough so that the network 104 only encompasses a single time zone. However, more extensive access networks 104, such as cellular phone networks, may conceivably cover more than one time zone. This latter situation is illustrated in FIG. 1, where the access network 104 has two access regions 114, 116. Each access region 114, 116 has an associated time zone 118, 120, respectively. These time zones 118, 120 may be used to calculate the current local time experienced by the user 122 of the device 102.

Generally, the time zones 118, 120 reflect the standard time used within each respective access region 114, 116. Time zones may be expressed as an integral number of hours offset from a time scale known as Universal Time, Coordinated (UTC). UTC is also known as Greenwich Mean Time (GMT) or Zulu Time. Time zones may also be expressed using an identifier such as EET for Eastern European Time and CST for Central Standard Time. A time zone is often described using both the identifier and an offset from GMT, such as “EET GMT+2.” Time zone identifiers may be accompanied with other data that describes whether the local regions 114, 116 conform to daylight savings time (DST), or any other system of shifting local time depending on the seasons.

Although the time zones 118, 120 may be expressed using generally accepted nomenclature as described above, it will be appreciated that any data representation known in the art may be used to describe the time zones 118, 120. For example, instead of using descriptors such as “EET” for the time zone, the time zone may be expressed as a 5-bit integer (signed or unsigned) representing an offset from GMT. In addition, other local time measures may be provided with or instead of whole hour offsets from GMT. For example, there may be applications where an alternate measure of local time, such as solar time, may be useful. Solar time is based on the apparent angular motion of the sun across the sky and is calculated using the difference between the local longitude and the longitude used to define the local time zone. For most applications, however, an offset in whole hours from GMT is sufficient to define local time.

Generally, people use local time as a basis for scheduling daily routines, such as waking, eating, sleeping, etc. Therefore, it is natural that the mobile device user 122 expects that time-based services provided via the mobile device 102 will adjust to account for the local time. This may not be an issue for a user that never changes time zones. However, for highly mobile users 122 (e.g., frequent travelers), it may be important to ensure certain time-based events occur with reference to the local time of the user 122. Such a user 122 may pass through many time zones while traveling. Therefore it may be non-trivial to account for the local time zone where the user 122 is currently located.

Some time-based events may not originate with the user device 102, but may originate at a remotely situated network node. This remote node may not have knowledge of the local time zone of the user device 102. For example, the user device 102 may not be connected to the access network 104 when the remote node subscribes to the service. Even when the user device 102 is coupled to the access network 104, the default network environment 100 may not provide an easy way to determine the time zone where the device 102 is currently located.

Because the user device 102 is directly coupled to at least one element of the access network 104, one or more elements of the access network 104 typically have the information needed to determine the current time zone of the device 102. One such element that may be used to track time zones of mobile devices is an access gateway 126. As shown in FIG. 1, the access gateway 126 couples the access network 104 to a core network 124 via a service gateway 128 of the core network 124. The core network 124 is where the device 102 and/or a third party may subscribe to time-based services. The time-based events that occur in response to the services may originate at the core network 124, although the events more commonly originate at a service domain 130.

The core network 124 is at the heart of present-day mobile communication networks. The core network 124 provides support for network features and telecommunications services, including essential functions such as session and call control, charging, mobility, and security. The core network interfaces with other network elements, including mobile devices 102, access networks 104 and service domains 130. The service domain 130 is where the services are actually operated.

The core network 124 may include a service portal 132 that is configured for providing services to mobile devices 102. The service portal 132 may include a User Interface (UI) 134 that allows subscribers to view service catalogs and subscribe to services. A service ordering and delivery platform 136 may also be included as part of the service portal 132 for the ordering and delivery of services. Generally, the service ordering and delivery platform 136 accepts service requests via the UI 134 and fulfills those requests via service elements 138 that reside in one or more service domains 130.

When the user/subscriber 122 subscribes to a service via the service portal 132, the user 122 may wish that the service be fulfilled later. For a time-based service this means that the subscriber 122 specifies the time of fulfillment (e.g. download a specific ring-tone tomorrow at 08:00 or send a picture to my friend next week Tuesday at 10:00). For a service having a validity period, this means that the subscriber 122 specifies the start time of the validity period (e.g. send me the latest sport news for one week starting 08:00 tomorrow). If the user 122 is located in different time zone than the service portal 132, the service may be fulfilled at an incorrect time because the service portal 132 does not know the user's time zone 118.

In order to provide service providers with indications of the user's current time zone 118, network elements of the access network 104 can be enabled to keep track of user locations. For example, the access gateway 126 can implement a mapping of user geographical locations to time zones. If the access gateway 126 controls an area that is within a single time zone, the gateway 126 can use the same time zone indicator for all access network traffic. If the access gateway 126 controls an area that expands two or more time zones, the gateway must know the time zones of each of the sub-areas. The determination of time zones in such a case may be made by examining which part of the network the data traffic comes from. This is analogous to determining at which cell in a cellular radio access network (RAN) the device 102 is connected, but with lower granularity.

In the illustrated example, the access gateway 126 services two time zones 118, 120. The device 102 is currently in time zone 118. Therefore, the mobile device 102 will have time zone 118 associated with it in at least some data traffic, as indicated by identifier 140. A second mobile device 142 and associated user 144 are located in the other time zone 120. Therefore traffic associated with the device 142 may include an identifier 146 that describes this time zone 120. Note that the illustrated identifiers 140, 146 associate a time zone with user identities (e.g., user account names) and device identities (e.g., media access control addresses, device serial numbers, processor IDs, etc.). It will be appreciated that any other identities associated with the network traffic may be associated with time zones, including identifiers associated with the requested time-based service, network identifiers, etc. Also, the time zones 118, 120 may be associated with any traffic between the devices 102, 142 and other network elements. Typically, the time zone identifiers will be included in a subset of network messages, such as messages relating to initiating services via the service portal 132.

The user location time zone information 140, 146 may be passed to the service portal 132 and used to determine when the subscribed service should be fulfilled or started. The user location time zone information 140, 146 may be passed to the service portal 132 via the service gateway 128 (as shown) when a user data connection is open. Alternatively, when there is no user data connection, the user location time zone information 140, 146 may be passed directly from the access gateway 126 to the service portal 132 as indicated by path 133. Depending on the use case, the access gateway 126 may update the user time zone information if it changes. To accomplish these updates, the service portal 132 may contact the relevant access gateway 126 and indicate that the user location time zone needs to be tracked and updated. The service portal 132 may utilize the services of a location register 148 in order to find the access gateway 126 associated with the devices 102, 142. Generally, the location register 148 is a database that can be used to determine the network location of user devices 102, 142, such as by providing addresses of access gateways 126 and/or other network access elements associated with the devices 102, 142.

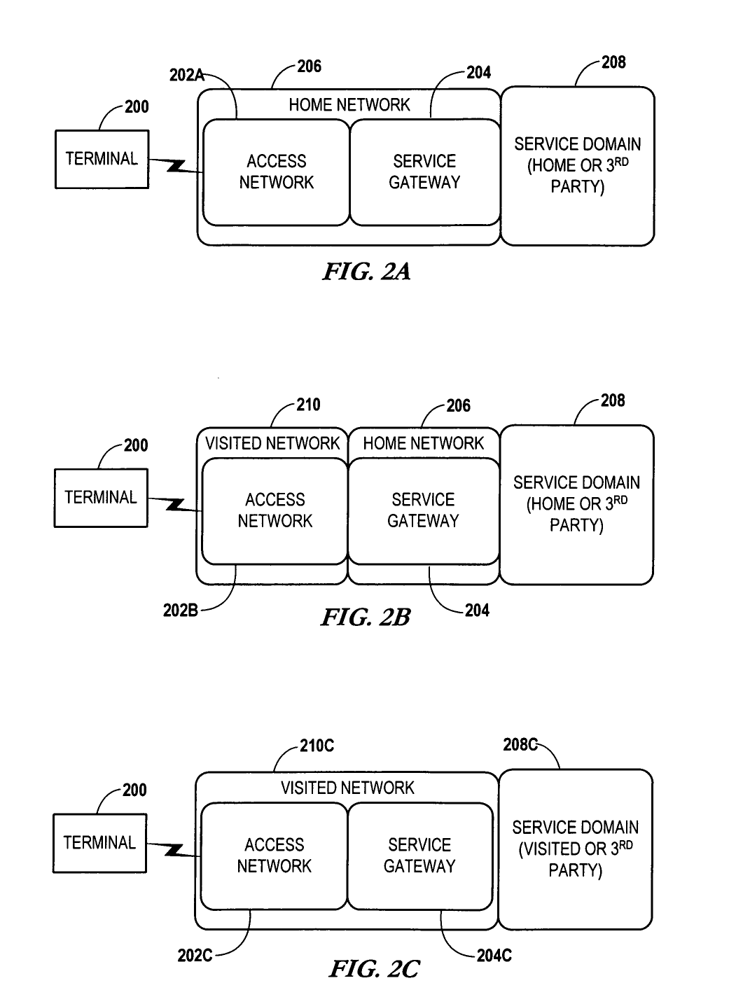

In reference now to FIGS. 2A-C, block diagrams illustrate various types of roaming scenarios that may be encountered in a time zone tracking system according to embodiments of the present invention. In FIG. 2A, a non-roaming scenario is illustrated. A user terminal 200 communicates with an access network 202A and a service gateway 204 that are both located within the user's home network 206. The service gateway 204 is part of a core network that provides service control and fixed connectivity to other access points, to other fixed networks, and to service resources, such as databases, interactive announcements, and content delivery. The service gateway 204 takes care of communication between the public packet-switched data networks and the core network. The services domain 208 may be part of the home network 206 or provided as part of a third party service and/or network.

In FIG. 2B, the terminal 200 is connected to an access network 202B that is part of a visited network 210, thus the terminal 200 is in a home GGSN roaming mode. However, the terminal 200 may still access the service gateway 204 located within the home network 206, and the service domain 208 may still be part of the home network 206 or a third party network. This scenario may be referred to as the home service gateway roaming model.

In FIG. 2C, the terminal 200 communicates with an access network 202C and a service gateway 204C that are both part of a visited network 210C. In this scenario, the service domain 208C may be part of the visited network 210C or provided by a third party network. This scenario may be referred to as the visited service gateway roaming model.

In each scenario of FIGS. 2A-C, the access networks 202A, 202B, 202C are responsible for determining the correct time zone of the terminal 200. If the any of the access networks 202A, 202B, 202C cover only a single time zone, the time zone will be a constant with reference to the connection location of the terminal 200. If any of the access networks 202A, 202B, 202C cover two or more time zones, then the time zone may be dependent on the network entry point (e.g., RAN cell) used by the terminal 200.

There are at least three different use cases in which time zone tracking may be used to determine service fulfillment time: 1) determining service fulfillment time based on the time zone at the subscriber's location when the service was subscribed, where the subscriber is the same as the service consumer; 2) determining service fulfillment time based on the time zone at the subscriber's current location, where the subscriber is the same as the service consumer; and 3) determining the service fulfillment time based on the time zone at the service consumer's location, where the subscriber is different from the service consumer.

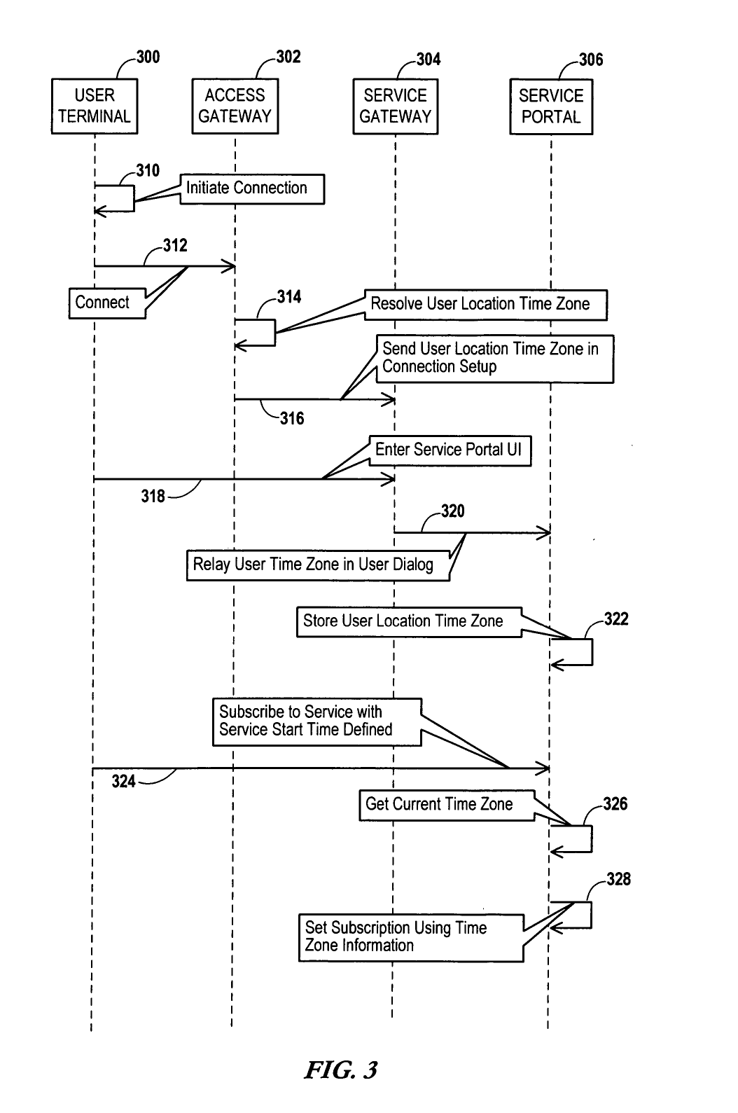

An example of the first use case is illustrated in FIG. 3. FIG. 3 is a sequence diagram showing time zone determination upon initial subscription according to embodiments of the present invention. The network entities in FIG. 3 include a user terminal 300, an access gateway 302, a service gateway 304, and a service portal 306. These network entities typically function as described for similar components shown in FIGS. 1 and 2. The sequence is initiated when the user terminal 300 initiates a connection 310. The connection may be initiated 310, for example, by powering on the terminal 300. Next the terminal 300 connects 312 to an access gateway 302 that is part of an access network where the terminal 300 is currently situated.

After receiving the connection request 312 from the terminal 300, the access gateway 302 will resolve 314 the time zone of the terminal 300. Resolving 314 the time zone may involve using a constant value associated with the entire access network, or may involve determining the time zone of an access point to which the terminal 300 is coupled. The access gateway 302 then sends the resolved “User Location Time Zone” to the service gateway 304 as part of a connection setup 316. The connection setup 316 is typically performed each time a user session is established. After connection setup 316, the service gateway 304 is aware of the time zone before the user subscribes to any service.

To subscribe to a service, the user may enter 318 a UI (e.g., UI 134 in FIG. 1) of the service portal 306 via the service gateway 304. As a part of this user interaction, the service gateway 304 relays 320 the time zone information to the service portal 306 via a user dialog. The service portal 306 then stores 322 the time zone information. When the user subscribes 324 to a service to be fulfilled later, the service ordering and delivery platform of the service portal 306 retrieves 326 the time zone information and sets 328 the fulfillment time accordingly.

It will be appreciated that the interactions illustrated in FIG. 3 are presented for illustration purposes only, and that the interactions may occur in different sequences and between different entities. For example, the service gateway 304 may be enabled to relay 320 the time zone information before and/or after the user subscribes 324 to the service. Also, some intermediary interactions may be omitted for purposes of brevity. For example, entering 318 the service portal UI may involve a first interaction between the terminal 300 and the access gateway 302, and then a second interaction between the access gateway 302 and the service gateway 304. The access gateway 302 may be queried directly by the service portal 306 and not via the service gateway 304 when a PDP context is not open and time zone information of a third party is requested. The access gateway 302 may also be queried directly by the service portal 306 in architectures that do not utilize a service gateway, such as Location Services (LCS) architecture.

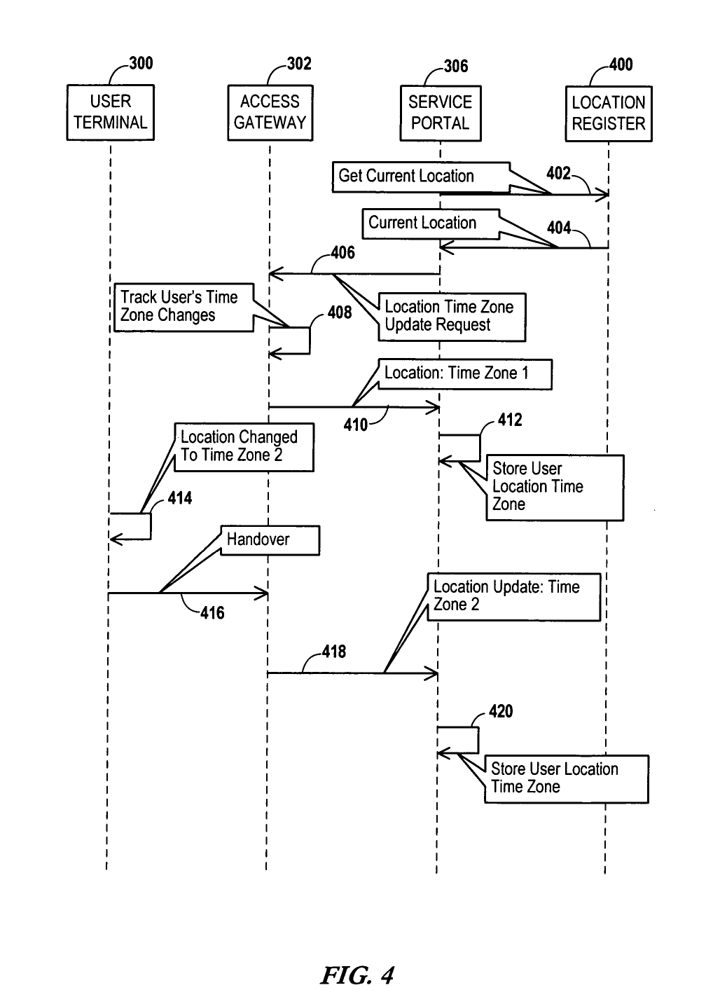

In reference now to FIG. 4, a sequence diagram shows an example sequence for updating time zone information according to embodiments of the present invention. The procedure described in FIG. 4 can be used to retrieve and track the time zone of any service consumer. This includes the situation when the subscriber of the service is different from the consumer (e.g. a friend to whom the subscriber orders the service). Equivalent network entities in FIG. 4 are identified with the same reference numbers as in FIG. 3, and the functions of these entities may be substantially the same as described above. FIG. 4 also includes a location register 400 that may be used to determine the access network currently being used by the terminal 300. It is assumed in this example that the access gateway 302 services an access network that spans more than one time zone.

Due to a prior service request (not shown), the service portal 306 requests 402 the user's current location from the location register 400. The prior service request may have been initiated from the user terminal 300 or from a third party device. The location register 400 replies 404 with a reference to the access gateway 302 that controls the user's mobile data connection. The service portal 306 sends a request 406 for user location time zone update to the access gateway 302. Thereafter, the access gateway begins to track 408 the time zone changes associated with the terminal 300. The access gateway 302 may optionally send 410 the current time zone information to the service portal 306, where it is stored 412. When the user changes to different time zone 414, the access gateway 302 detects this change. The change may be detected, for example, when the terminal 300 is handed over 416 to a new access point (e.g., base station transceiver). The access gateway 302 then sends an update 418 to the service portal 306, which stores 420 the updated time zone information.

It will be appreciated that the procedures shown in FIG. 4 may be used to determine a user's time zone even when the terminal 300 is not connected to the mobile network. For example, the access gateway 302 and/or location register 400 may cache the location and/or time zone of the terminal 300 based on the last access point to which the terminal 300 was connected. These cached location/time zone values may be continually updated based on repeated monitoring of connections to network access points by the terminal 300.

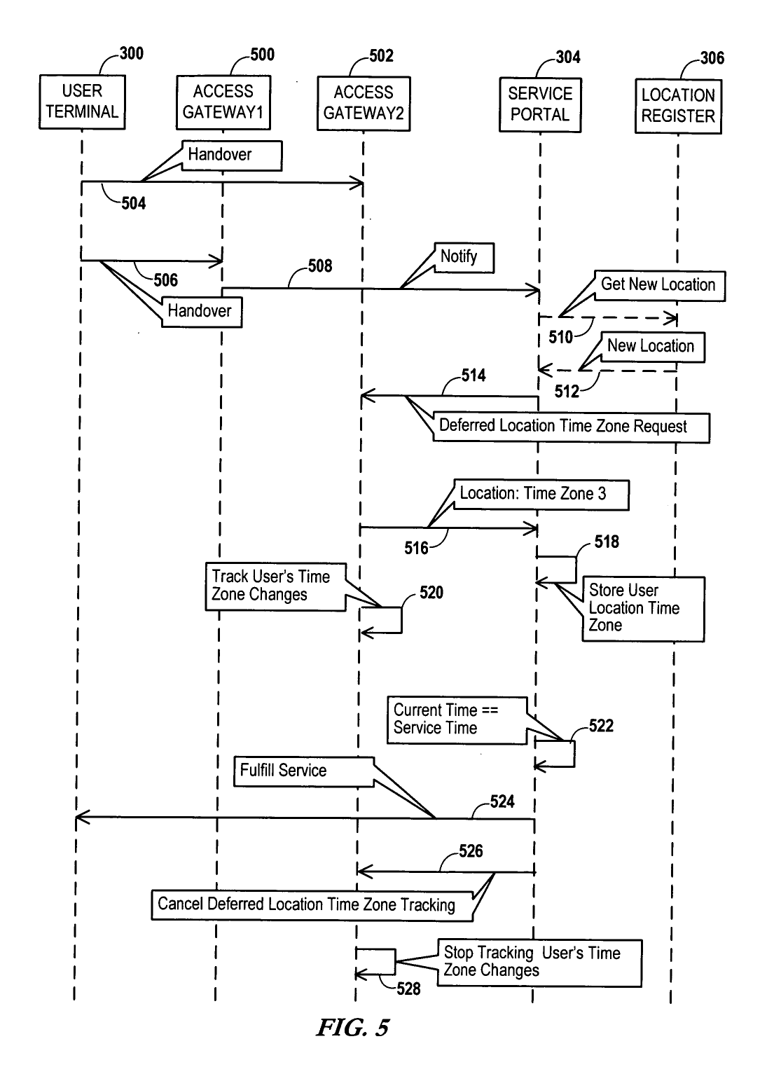

In reference now to FIG. 5, a sequence diagram illustrates updating time zone information during a handover between access networks according to embodiments of the present invention. Equivalent network entities in FIG. 5 are identified using the same reference numbers as in FIG. 3 and 4. In this diagram, the terminal 300 is assumed to be initially connected via a first access gateway 500, and has subscribed to time-based event services via the service portal.

The illustrated sequence begins when the terminal 300 performs a handover from the first access gateway 500 to a second access gateway 502. Generally, this handover will involve communications with both gateways 500, 502, as indicated by handover messages 504 and 506. The first access gateway notifies 508 the service portal 304 of the handover. The notification 508 may or may not include the address of the second access gateway 502. If notification 508 does not contain the new address, the address can be fetched 510, 512 from the updated location register 306. In either case, the service portal 304 sends a request 514 for user location time zone updates to the second access gateway 502. The second access gateway 502 then sends the current time zone information 516 to the service portal 304, which stores 518 the time zone information. Thereafter, the second access gateway 502 repeatedly tracks 520 the time zone changes.

In any of the above scenarios described in relation to FIGS. 3-5, the service is fulfilled when the user-defined time for the event passes. This is illustrated in FIG. 5, where the service portal 304 (or service providers accessed via the portal 304) determines 522 that it is time to fulfill the service. After the service is fulfilled 524, the time zone updates are not required anymore. The service portal 304 may either terminate the update requests by sending a message 526 to the appropriate access gateway 502. The access gateway 502 then stops 528 tracking time zone changes of the terminal 300. Alternatively, the original request 514 may have a validity, or keep-alive, time. Once this validity time has passed, the access gateway 502 automatically stops 528 tracking time zone changes of the terminal 300.

In reference to the previously described use case where the service fulfillment is based on the user's time zone at the time of service subscription, procedures such as those shown in FIGS. 3 and/or 4 may be used. If a procedure such as shown in FIG. 4 is used, time zone updates (e.g., tracking 408 and updates 418) may be not be needed because the use case only involves determining the time zone data at a single point in time, i.e., the subscription time.

In use cases where service fulfillment is based on the current location, the procedures such as shown in FIG. 3 may be used for retrieving the initial time zone information. Thereafter, procedures such as shown in FIGS. 4 and 5 may be utilized to provide time zone updates. When the service consumer is different from the service subscriber (e.g., the subscription does not originate from the terminal 300 where the service will be received), the service request is directed from the subscriber to the service portal 306. The time zone update requests are then directed to the location register 400 and serving access gateway 302, 500, 502 associated with the terminal 300 of the service consumer. The service consumer may be a customer of another network operator.

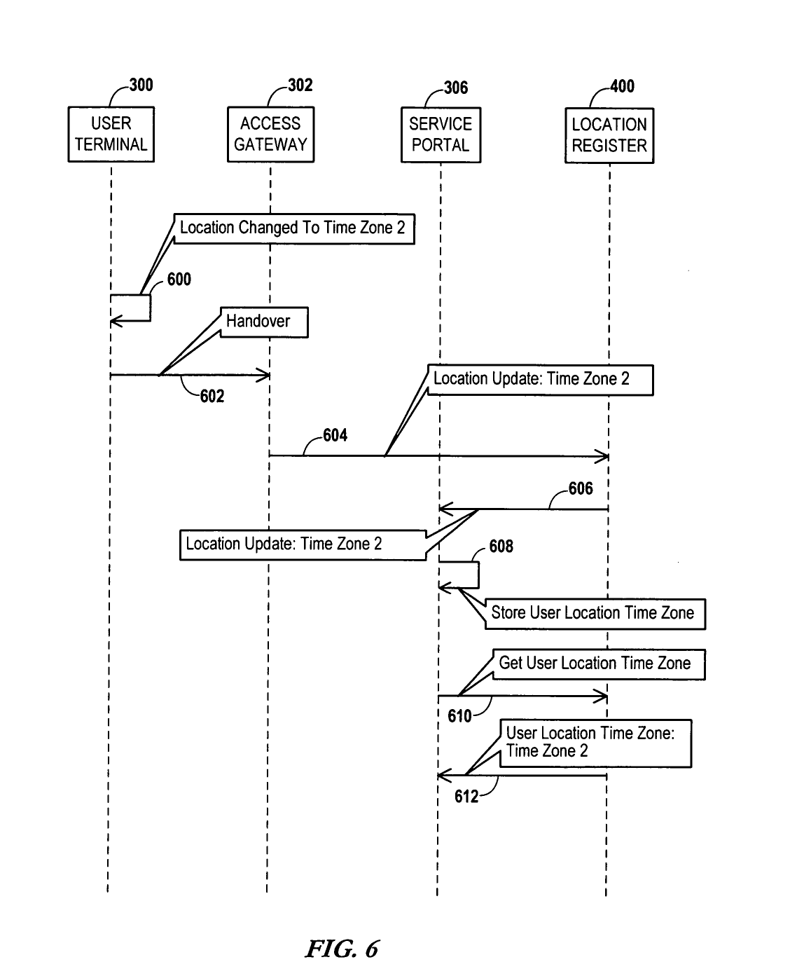

In reference now to FIG. 6, an alternative solution is illustrated for storing and updating the user time zone information according to embodiments of the present invention. The sequence diagram uses analogous functional components having the same reference numbers as in FIGS. 3 and 4. In this sequence, the access gateway 302 is tracking time zone changes of the terminal 300 that occur within a single access network. When a time zone change occurs 600, the access gateway 302 may be informed by a handover 602 between inter-network access points and the like. The access gateway 302 then updates 604 the location register 400 whenever a time zone change occurs. The location register 400 may then push the time zone change to the service portal 306. Alternatively, the service portal 306 may regularly poll 610, 612 for time zone information from the location register 400.

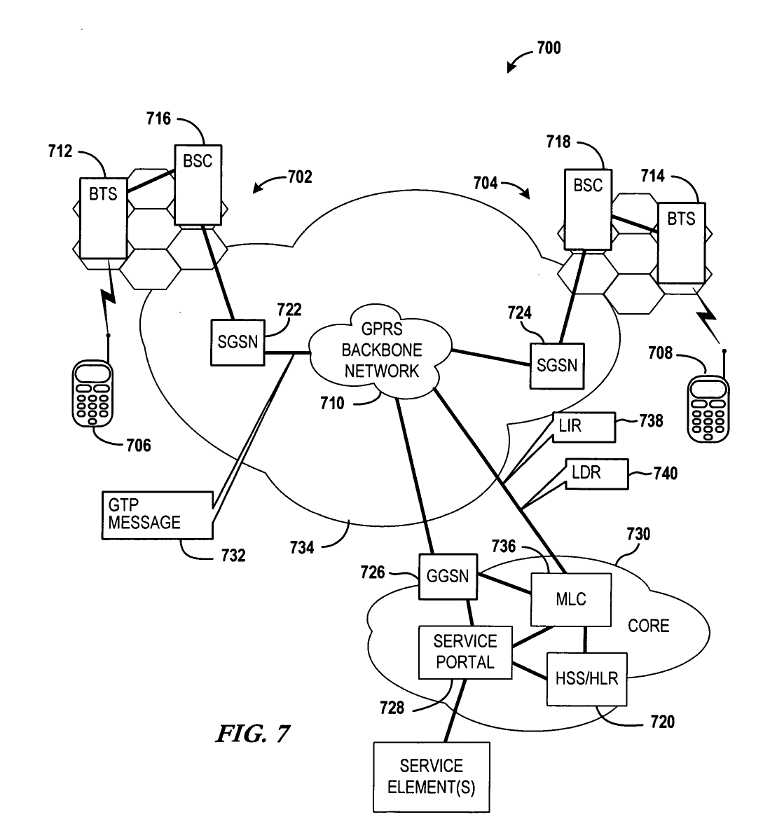

It will be appreciated that the present invention may be implemented in any mobile telecommunications infrastructure known in the art. Such infrastructures may include wireless network technologies such as the Global System for Mobile Communications (GSM), General Packet Radio Service (GPRS), Universal Mobile Telecommunications System (UMTS), Personal Communications Service (PCS), Time Division Multiple Access (TDMA), Code Division Multiple Access (CDMA), Wideband CDMA (WCDMA), Ultra Wideband (UWB), and any other mobile network transmission technology. In FIG. 7, a block diagram illustrates a more particular example of communicating user location time zones in a GSM/GPRS network 700 in accordance with embodiments of the present invention.

A GSM network may include various Base Station Subsystems (BSS) 702, 704 etc. These BSS 702, 704 provide wireless access for Mobile Stations (MS) 706, 708 to access the GPRS network 710, and/or any other voice/data networks such as cellular networks, the Internet, IP Multimedia Subsystem (IMS), etc. The BSS 702, 704 include, for example, Base Station Transceivers (BTS) 712, 714 to which the MS 706, 708 respectively communicate, as well as Base Station Controllers (BSC) 716, 718 that communicate with associated BTS 712. 714. The BSC 716, 718 may respectively communicate with switching system components such as Mobile Switching Centers (MSC) (not shown) which in turn may be associated with databases such as a Home Location Register (HLR)/Home Subscriber Service (HSS) 720.

In GPRS environments, communication through the GPRS backbone network 710 is facilitated by an interface device such as Serving GPRS Support Nodes (SGSN) 722, 724. The SSGNs 722, 724 may communicate with one or more Gateway GPRS Support Nodes (GGSN) 726 of a core network 730. In regards to the generic infrastructure illustrated in FIG. 1, the SGSN 722, 724 act as access gateways (e.g., gateway 126 in FIG. 1), and the GGSN 726 acts as service gateway (e.g., service gateway 128 in FIG. 1). There is no standardized GPRS equivalent for the service portal, which is here represented as a portal 728 of the core network 730. The HSS/HLR 720 acts as a location register 148 as shown in FIG. 1.

In one embodiment of the invention, the GPRS Tunneling Protocol (GTP) may be used to transfer the time zone information from the SGSN 722 to the GGSN 726. GTP is a GPRS protocol used in transmitting user data packets and signaling between GPRS support nodes (GSN) over the GPRS backbone network 710. In particular, a GTP message 732 that contains time zone information may be transferred between the SGSN 722 to the GGSN 726 upon a Packet Data Protocol (PDP) context setup and modification. This is analogous to transferring time zone information from the access gateway 126 to the service gateway 128, as described in relation to FIG. 1.

When a PDP context is opened, the GTP message 732 “Create PDP Context Request” is sent from the SGSN 722, 724 to the GGSN 726. When the SGSN 722, 724 is changed during an open PDP context, the GTP message 732 “Update PDP Context Request” is sent from the SGSN 722, 724 to the GGSN 726. These requests include a header and information elements (IE) that may be mandatory, conditional, or optional. An information element, called “user location time zone”, may be used with these requests in order to carry out embodiments of the invention. The user location time zone IE may include, for example, the user's local time offset from the GMT and the information about the daylight saving time (DST) period.

The GGSN 726 may be enabled to store the time zone information for the PDP context. The GGSN 726 may then provide the time zone information to the service portal 728. If the MS 706, 708 interact with the service portal 728 based on HTTP, the GGSN 726 could include the time zone information to the initial HTTP request header. The service portal 728 then extracts the time zone information from the HTTP header. Several alternative ways to pass the information from the GGSN 726 to the service portal 728 can be specified, including a specialized HTTP POST method, remote procedure call (e.g., Simple Object Access Protocol), etc.

In another arrangement, time zone information can be communicated directly from the SGSN 722 to the service portal 728 using extensions to the Location Services (LCS) architecture and signaling specified in 3GPP TS 23.271. Location Services are used to retrieve the geographical location of the MS 706, 708. Location Services may be available in both circuit and packet switched domains (GSM, 2G, 3G). The MS 706, 708 may alternately be referred to as User Equipment (UE), as is the case in the LCS specifications. LCS is implemented on the network structure through the addition a network node known as the Mobile Location Center (MLC) 736.

The MLC 736 provides location information regarding MS 706, 708 to an LCS client. An LCS client may be any software and/or hardware entity that interacts with a LCS Server for the purposes of obtaining MS location information. The LCS client requests the location from the access network 734. In a GSM/GPRS network, the location request is forwarded via the MLC 736 to the SGSN 722, 724, and then to the BSC 716, 718.

Depending on requested positioning method, the BSC 716, 718 forwards the requests further to the MS 706, 708 through other elements of the BSS 702, 704. The MS 706, 708 may determine its location and send this location back in a response. The LCS architecture also takes care of selecting the correct SGSN 722, 724, determining changes in mobility, interconnections between different operator domains, etc. LCS signaling between MLC 736, HSS/HLR 720 and SGSN 722 utilizes the Mobile Application Part (MAP) protocol.

The user time zone information can be determined at the SGSN 722, 724 as it may be assumed that a BSC 716, 718 covers a single time zone and the SGSN is aware of the BSS 702, 704 under which the MS 706, 708 locates. The LCS signaling may be extended so that it is possible to request MS Location Time Zone using similar mechanisms as used to determine location. The extension may be added to both LCS request types, the Location Immediate Request (LIR) 738 and Location Deferred Request (LDR) 740. When an SGSN 722, 724 receives LIR 738 for MS Location Time Zone, it maps the MS location (under a BSS) to the corresponding time zone and sends that back in a response. When an SGSN 722, 724 receives LDR 740 for UE Location Time Zone, the SGSN 722 starts tracking the time zone changes. The SGSN 722, 724 sends the updated UE Location Time Zone to the requestor whenever the time zone changes. This is performed until the SGSN 722, 724 changes or the LDR 740 is cancelled using normal LCS procedures.

The UE Location Time Zone should also be added to any LCS message that the SGSN 722, 724 sends or forwards towards the core network 730. This ensures that the time zone information is available upon other location requests. By automatically adding time zone data to LCS messages, there is no need to request time zone data separately in cases where geographical and time zone information are both required. Implementing a specific UE Location Time Zone request is beneficial since it may be terminated at the SGSN 722, 724, thus the unnecessary signaling to elements from BSC 716, 718 to MS 706, 708 may be avoided when only time zone information is required.

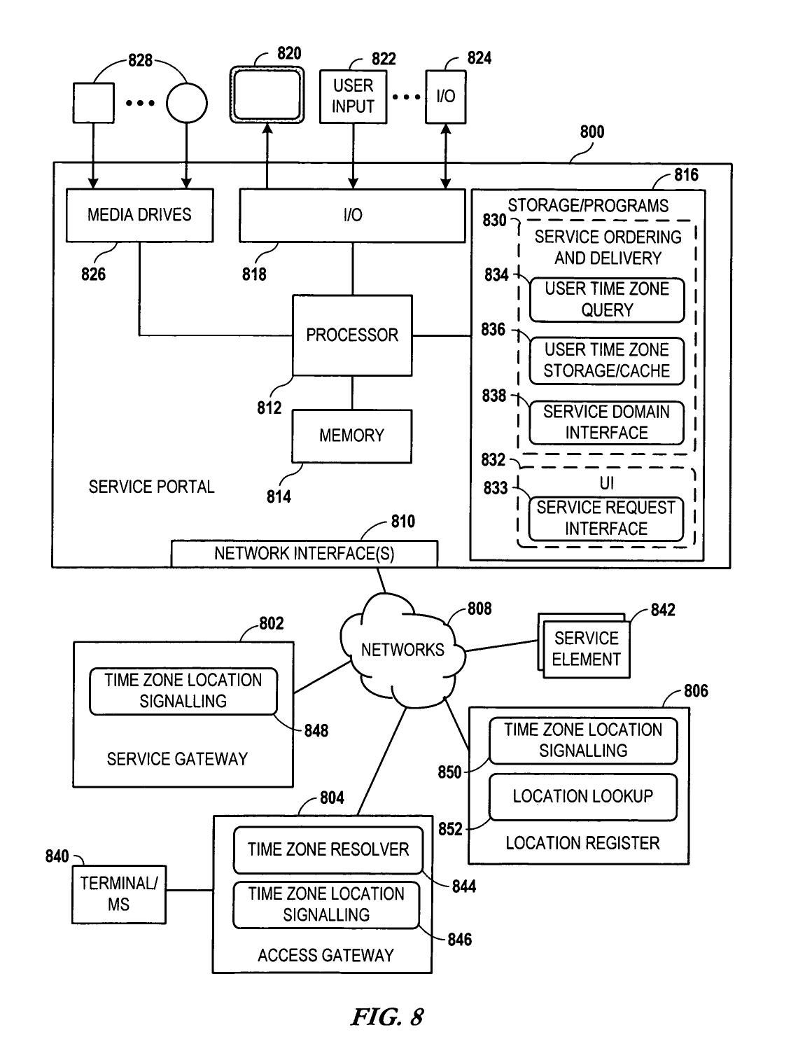

Many types of apparatus may be configured to perform roles as service portals, service gateways, access gateways, and similar server devices. In reference now to FIG. 8, a block diagram shows a representative computing implementation of various computing arrangements capable of carrying out operations in accordance with the invention. An example computing arrangement 800 is suitable for performing the functions of the service portal. Other computing arrangements 802, 804, 806 are capable of carrying out operations of the service gateway, access gateway, and location register, respectively. It will be appreciated that the software and hardware features described in relation to the service portal arrangement 800 are also generally applicable to the service gateway arrangement 802, the access gateway arrangement 804, and the location register arrangement 806.

The service gateway arrangement 800 includes a central processor 812, which may be coupled to memory 814 and data storage 816. The processor 812 carries out a variety of standard computing functions as is known in the art, as dictated by software and/or firmware instructions. The storage 816 may represent firmware, hard-drive storage, etc. The storage 816 may also represent other types of storage media to store programs, such as programmable ROM (PROM), erasable PROM (EPROM), etc.

The processor 812 may communicate with other internal and external components through input/output (I/O) circuitry 818. The service gateway arrangement 800 may therefore be coupled to a display 820, which may be any type of known display or presentation screen such as LCD displays, plasma display, cathode ray tubes (CRT), etc. A user input interface 822 is provided, including one or more user interface mechanisms such as a mouse, keyboard, microphone, touch pad, touch screen, voice-recognition system, etc. Any other I/O devices 824 may be coupled to the service gateway arrangement 800 as well.

The service gateway arrangement 800 may also include one or more media drive devices 826, including hard and floppy disk drives, CD-ROM drives, DVD drives, and other hardware capable of reading and/or storing information. In one embodiment, software for carrying out the data insertion operations in accordance with the present invention may be stored and distributed on CD-ROM, diskette or other form of media capable of portably storing information, as represented by media devices 828. These storage media may be inserted into, and read by, the media drive devices 826. Such software may also be transmitted to the service gateway arrangement 800 via data signals, such as being downloaded electronically via one or more network interfaces 810. The service gateway arrangement 800 may be coupled to other computing devices, such as the servers 802, 804, 806 and/or mobile terminals 840, via the network interface 810. The network interface 810 may be coupled to one or more networks 808 that allow ultimate connection to the various landline and/or mobile client devices.

In accordance with one embodiment of the invention, the storage 816, memory 814, and/or media devices 828 store the various programs and data used in connection with the present invention. In the illustrated embodiment of FIG. 8, the data storage 816 is shown storing various program modules operable in connection with the processor 812. In particular, the data storage 816 may contain modules that perform the functions of service ordering and delivering 830 and UI 832.

The service ordering and delivery module 830 contains sub-modules that enable the service portal arrangement 800 attach user time zones with service requests. For example, the UI module 832 may contain a service request interface 833 capable of receiving requests for time-based services. Similarly, the service ordering and delivery module 830 may contain a user time zone query module 834 that interfaces with network elements such as the service gateway 802, the access gateway, 804, and the location register 806 in order to determine the current time zone of a mobile station 840. Once obtained, this information may be stored and later accessed via a user time zone storage/cache module 836. Time zone information may be communicated to service elements 842 via a service domain interface 838 in order to fulfill a requested service.

The access gateway arrangement 804 may contain hardware components similar to that described in relation to the service portal arrangement 800. In addition, the access gateway arrangement 800 may contain a time zone resolver module 844 that is capable of determining a time zone of the MS 840 based on a network endpoint being utilized by the MS 840. The access gateway arrangement 800 may also contain a time zone location signaling module 846 that is part of a location-signaling infrastructure used on the communication networks 808. The service gateway arrangement 802 and location register arrangement 806 may contain compatible signaling modules 848 and 850, respectively. These signaling modules 846, 848, 850 may be used to track selected user time zone locations for the benefit of the service portal arrangement 800. In particular, such signaling message may be used to perform queries by the user time zone query sub-module 834 that is part of the service ordering and delivery module 830. In addition, the location register arrangement 806 may contain a location lookup function module 852 that may be used in alternate location lookup procedures described herein.

The computing arrangements 800, 802, 804, 806 of FIG. 8 are provided as representative examples of computing environments in which the principles of the present invention may be applied. From the description provided herein, those skilled in the art will appreciate that the present invention is equally applicable in a variety of other currently known and future mobile and landline computing environments. Thus, the present invention is applicable in any known computing structure where data may be communicated via a network.

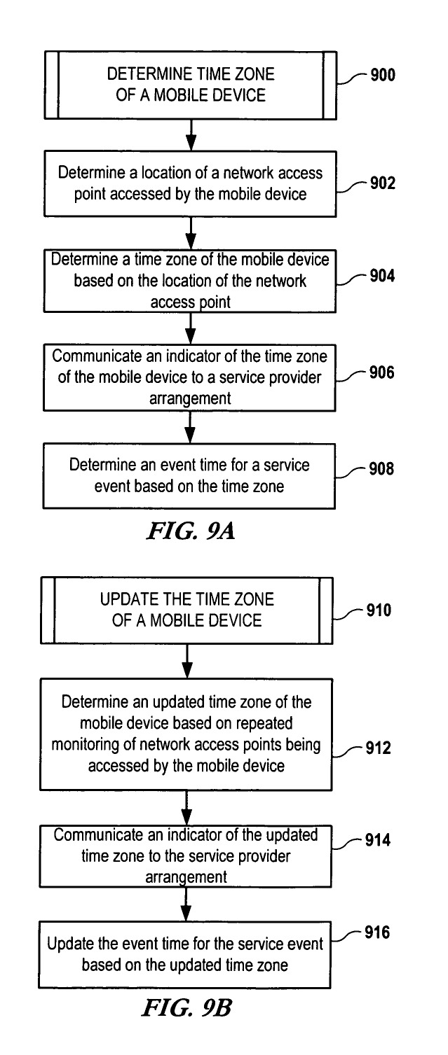

Turning now to FIG. 9A, a flowchart illustrates a procedure 900 for determining the time zone of a mobile device. First, a network element such as a service portal will determine 902 the location of a network access point accessible by the mobile device. This may involve querying a location register or similar database to determine an address of a network access gateway responsible for the device's access network. Based on this location, the time zone of the mobile device may be determined 904. This may involve using the address of the access gateway to query the access gateway for the time zone associated with the mobile device.

An indicator of the time zone is communicated 906 to the service provider arrangement, and this time zone data can be used to determine 908 and event time for a service event. The procedure 900 may be used for one time updates of user time zone locations, such as during connection initiation or when time zone data is only required at the time of service subscription. In addition, repeated updates of user time zone may be required. A procedure 910 for updating user time zone data according to embodiments of the invention is shown in FIG. 9B.

First, an updated time zone of the mobile device is determined 912 based on repeated monitoring network access points being accessed by the mobile device. This determination may involve, for example, regular polling of access gateways by a core service element. In other arrangements, the access gateway may be responsible for monitoring changes in the location of the mobile device. In this latter arrangement, coordination of time zone tracking between access gateways may be needed when the mobile device changes between different access networks. The updated time zone indicators are communicated 914 to the appropriate service provider, and this update is used to update 916 the service event.

Hardware, firmware, software or a combination thereof may be used to perform the various functions and operations described herein. Articles of manufacture encompassing code to carry out functions associated with the present invention are intended to encompass a computer program that exists permanently or temporarily on any computer-usable medium or in any transmitting medium which transmits such a program. Transmitting mediums include, but are not limited to, transmissions via wireless/radio wave communication networks, the Internet, intranets, telephone/modem-based network communication, hard-wired/cabled communication network, satellite communication, and other stationary or mobile network systems/communication links. From the description provided herein, those skilled in the art will be readily able to combine software created as described with appropriate general purpose or special purpose computer hardware to create a system, apparatus, and method in accordance with the present invention.

The foregoing description of the exemplary embodiments of the invention has been presented for the purposes of illustration and description. It is not intended to be exhaustive or to limit the invention to the precise form disclosed. Many modifications and variations are possible in light of the above teaching. It is intended that the scope of the invention be limited not with this detailed description, but rather defined by the claims appended hereto.

What is claimed is:

1. A method of providing time-based network services to a mobile device that is capable of being coupled to a network, comprising:
determining a location of a network access point accessible by the mobile device;
determining a time zone of the mobile device based on the location of the network access point;
communicating an indicator of the time zone of the mobile device to a service provider; and
determining an event time for a service event based on the time zone, wherein the service provider targets the service event for the mobile device.

2. The method of claim 1, further comprising:
determining an updated time zone of the mobile device based on repeated monitoring of network access points being accessed by the mobile device;
communicating an indicator of the updated time zone to the service provider; and
updating the event time for the service event based on the updated time zone.

3. The method of claim 2, wherein repeated monitoring of network access points being accessed by the mobile device comprises tracking handovers between a first access network that the mobile device is exiting and a second access network the mobile device is entering.

4. The method of claim 1, wherein determining the location of the network access point accessible by the mobile device comprises determining the location of the network access point when the mobile device initiates a connection at the network access point.

5. The method of claim 4, wherein initiating the connection at the network access point comprises initiating a packet switch data connection.

6. The method of claim 5, wherein initiating the packet switch data connection comprises a Packet Data Protocol (PDP) context setup.

7. The method of claim 1, wherein determining the time zone of the mobile device based on the location of the network access points comprises determining a current time zone of the mobile device when the mobile device is currently disconnected from the network based on the location of a last network access point accessed by the mobile device.

8. The method of claim 1, further comprising subscribing to the time-based service via the mobile terminal.

9. The method of claim 1, further comprising subscribing to the time-based service via a third-party device that is separate from the mobile terminal.

10. The method of claim 1, further comprising storing the indicator of the time zone at a location registry arrangement.

11. The method of claim 10, wherein communicating the indicator of the time zone of the mobile device to the service provider comprises retrieving the indicator of the time zone from the location registry arrangement.

12. The method of claim 10, further comprising:
determining an updated time zone of the mobile device based on repeated monitoring of locations of network access points being accessed by the mobile device; and
storing an indicator of the updated time zone at the location registry arrangement.

13. The method of claim 10, wherein communicating the indicator of the time zone of the mobile device to the service provider comprises retrieving the indicator of the time zone from the location registry arrangement when the service event is requested at the service provider.

14. The method of claim 10, wherein communicating the indicator of the time zone of the mobile device to the service provider comprises retrieving the indicator of the time zone from the location registry arrangement when the mobile device initiates a connection at the network access point.

15. The method of claim 1, wherein determining the time zone of the mobile device based on the location of the network access point comprises sending a location signaling message to the network access point.

16. The method of claim 15, wherein sending the signaling message comprises sending at least one of a Location Immediate Request (LIR) message and a Location Deferred Request (LDR) message.

17. A method of providing time-based network services to a mobile device that is capable of being coupled to a network, comprising:
determining locations of the mobile device based on repeated monitoring of network access points accessed by the mobile device;
determining updated time zones of the mobile device based on the locations of the network access points;
communicating indicators of the updated time zones of the mobile device to a service provider; and
determining an event time for a service event based on the updated time zones, wherein the service provider targets the service event for the mobile device.

18. The method of claim 17, wherein repeated monitoring of network access points accessed by the mobile device comprises tracking handovers between a first access network that the mobile device is exiting and a second access network the mobile device is entering.

19. The method of claim 17, wherein determining updated time zones of the mobile device based on the locations of the network access points comprises determining a current time zone of the mobile device when the mobile device is currently disconnected from the network based on the location of a last network access point accessed by the mobile device.

20. A data-processing arrangement, comprising:
a network interface capable of receiving data via a network;
a processor coupled to the network interface; and
a memory coupled to the processor, the memory having a service ordering and delivery module that causes the processor to,
receive via the network interface a service request for a time-based service event targeted for a mobile device;
determine a time zone of the mobile device based on a location of a network access point accessible by the mobile device; and
fulfill the service request using the time zone to determine an event time of the time-based service event.

21. The data-processing arrangement of claim 20, further containing a location module that causes the processor to determine the location of the network access point via a location registry arrangement.

22. The data-processing arrangement of claim 21, wherein the location registry arrangement comprises any combination of a Home Location Register (HLR) and a Home Subscriber Service (HSS).

23. The data-processing arrangement of claim 21, wherein the location module further causes the processor to determine the time zone of the mobile device from the location registry arrangement.

24. The data-processing arrangement of claim 20, wherein the service ordering and delivery module further causes the processor to,
receive via the network interface an indication of an updated time zone of the mobile device; and
update the event time of the time-based service event based on the updated time zone.

25. A data-processing arrangement, comprising:
a core network interface capable of receiving data via a core network;
an access network interface capable of communicating with devices coupled to a mobile access network;
a processor coupled to the network interface; and
a memory coupled to the processor, the memory having an access gateway module that causes the processor to,
receive a request for a time zone of a mobile device that is capable of accessing the mobile access network;
determine the time zone of the mobile device based on a location of a network access point of the mobile access network used by the mobile device; and
respond to the request with a reply that includes the time zone of the mobile device.

26. The data-processing arrangement of claim 25, wherein the request comprises a location-signaling message received via the core network interface.

27. The data-processing arrangement of claim 26, wherein the location signaling message comprises at least one of a Location Immediate Request (LIR) message and a Location Deferred Request (LDR) message.

28. The data-processing arrangement of claim 25, wherein the request comprises a connection initiated by the mobile device at the network access point.

29. The data-processing arrangement of claim 28, wherein the request is included as part of Packet Data Protocol (PDP) context setup.

30. The data-processing arrangement of claim 25, wherein the access gateway module further causes the processor to,
repeatedly monitor network access points of the mobile access network used by the mobile device to detect an updated time zone of the mobile device; and
communicate the updated time zone to an originator of the request for the time zone of the mobile device.

31. The data-processing arrangement of claim 25, wherein the access gateway module further causes the processor to,
detect the mobile device leaving the mobile access network; and
communicate to an originator of the request for the time zone that the mobile device is leaving the mobile access network.

32. A processor-readable medium having instructions stored thereon which are executable by a data processing arrangement capable of being coupled to a mobile access network, the instructions executable by the data processing arrangement for performing steps comprising:
receiving a request for a time zone of a mobile device that is capable of accessing the mobile access network;
determining the time zone of the mobile device based on a location of a network access point of the access network used by the mobile device; and
respond to the request with a reply that includes the time zone of the mobile device.

33. A data-processing arrangement, comprising:
a network interface capable of receiving data via a network;
a processor coupled to the network interface; and
a memory coupled to the processor, the memory having a location register module that causes the processor to,
determine a time zone of a mobile device based on a location of a network access point accessible by the mobile device;
store the time zone of the mobile device with location data associated with the mobile device; and
fulfill requests for the time zone of the mobile device for purposes of providing time-based network services targeted for the mobile device.

34. The data-processing arrangement of claim 33, further comprising a location signaling module that causes the processor to determine the time zone of the mobile device by sending a location signaling message to an access network that includes the network access point accessible by the mobile device.

35. The data-processing arrangement of claim 35, wherein the location signaling message comprises at least one of a Location Immediate Request (LIR) message and a Location Deferred Request (LDR) message.

36. The data-processing arrangement of claim 33, wherein the location register module comprises a Home Location Register (HLR)/Home Subscriber Service (HSS) module.

37. A processor-readable medium having instructions stored thereon which are executable by a data processing arrangement capable of being coupled to a network, the instructions executable by the data processing arrangement for performing steps comprising:
determining a time zone of a mobile device based on a location of a network access point accessible by the mobile device;
storing the time zone of the mobile device with location data associated with the mobile device; and
fulfilling requests for the time zone of the mobile device for purposes of providing time-based network services targeted for the mobile device.

38. A system for providing time-based network services to a mobile device that is capable of being coupled to a network, comprising:
means for determining a location of a network access point accessible by the mobile device;
means for determining a time zone of the mobile device based on the location of the network access point;
means for communicating an indicator of the time zone of the mobile device to a service provider arrangement;
means for determining an event time for a service event based on the time zone; and;
means for targeting the service event for the mobile device.
